(19) United States
(12) Patent Application Publication
(10) Pub. No.: US 2009/0201771 A1
(43) Pub. Date: Aug. 13, 2009

(54) Electronic Timepiece With Internal Antenna

(75) Inventor: Fumiaki Miyahara, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 12/361,635

(22) Filed: Jan. 29, 2009

(30) Foreign Application Priority Data
Feb. 7, 2008 (JP) 2008-028104
Oct. 3, 2008 (JP) 2008-258186

(51) Int. Cl. H01Q 7/08; G04C 11/02

(52) U.S. Cl. 368/47; 343/788

(57) ABSTRACT

An electronic timepiece with an internal antenna includes an outside case including a metal back cover, an antenna for receiving external radio frequency information, the antenna including a magnetic core that is long in one direction and is made from a magnetic material, and a coil that is wound around the magnetic core, a reception processor that processes the external radio frequency information received by the antenna, a module that houses the antenna and the reception processor and is housed inside the outside case, and a metal magnetic foil member that has greater magnetic permeability than the back cover and is positioned outside at least the lead-facing areas opposite the lead parts on the inside surface of the back cover facing the module. The magnetic core has a coil winding part around which is wound the coil positioned in the middle part in the lengthwise direction, and a pair of lead parts projecting from both sides of the coil winding part.

### CROSS-REFERENCE TO RELATED APPLICATIONS

Japanese Patent application Nos. 2008-028104, filed Feb. 7, 2008, and 2008-258186, filed Oct. 3, 2008, are hereby incorporated by reference in their entirety.

### BACKGROUND

1. Field of Invention

The present invention relates to an electronic timepiece with an internal antenna enabling receiving external radio frequency signals through the antenna.

2. Description of Related Art

Electronic timepieces with an internal antenna are known from the literature. Typical of such timepieces is a radio-controlled timepiece that receives external radio frequency signals carrying time information from an external source and uses this information to adjust the time kept by the timepiece. A problem with such an electronic timepiece with an internal antenna is that if the antenna is positioned opposite a metal back cover, the magnetic flux produced by the antenna creates an eddy current and the reception performance of the antenna may drop. Various configurations for reducing the effects of such eddy current have therefore been proposed. See, for example, Japanese Unexamined Patent Appl. Pub. JP-A-2006-53158.

The wristwatch taught in Japanese Unexamined Patent Appl. Pub. JP-A-2006-53158 houses a timepiece module in which an antenna is contained inside a case member including a metal watch case and a metal back cover. A magnetic sheet in which an amorphous or ferrite magnetic material is compounded in a plastic sheet is also affixed to the inside circumference surface of the watch case and the inside surface of the back cover facing the antenna.

However, unless a magnetic material with low permeability, specifically less than or equal to 1/100 the permeability of the antenna core, is used as the magnetic material compounded with the plastic sheet that is positioned between the metal back cover and antenna as described in Japanese Unexamined Patent Appl. Pub. JP-A-2006-53158, the plastic sheet will interfere with radio waves entering the antenna and cause a drop in antenna characteristics, including a drop in the reception performance of the antenna or a large shift in the tuning frequency of the antenna.

### SUMMARY OF INVENTION

With consideration for the foregoing problems, an electronic timepiece with an internal antenna according to the present invention improves the antenna characteristics by using a simple configuration.

An electronic timepiece with an internal antenna according to a first aspect of the invention includes an outside case including a metal back cover, an antenna for receiving external radio frequency information, the antenna including a magnetic core that is long in one direction and is made from a magnetic material, and a coil that is wound around the magnetic core, a reception processor that processes the external radio frequency information received by the antenna, a module that houses the antenna and the reception processor and is housed inside the outside case, and a metal magnetic foil member that has greater magnetic permeability than the back cover and is positioned outside at least the lead-facing areas opposite the lead parts on the inside surface of the back cover facing the module. The magnetic core has a coil winding part around which is wound the coil positioned in the middle part in the lengthwise direction, and a pair of lead parts projecting from both sides of the coil winding part.

In this aspect of the invention a metal magnetic foil member is positioned on the inside surface of the back cover at a position outside at least the areas that are opposite the lead parts of the antenna. In other words, when looking at the electronic timepiece with an internal antenna from the thickness direction perpendicular to the inside surface of the back cover, the metal magnetic foil member is positioned where there is no overlap with at least the lead parts of the antenna.

More specifically, radio waves carrying the external radio frequency information enter the inside of the magnetic core from the lead parts at both end parts of the magnetic core forming the antenna. If the metal magnetic foil member is positioned on the back cover in the lead-facing areas that are opposite the lead parts of the antenna, the external radio frequency information that enters the electronic timepiece with an internal antenna will be absorbed by this metal magnetic foil member, the amount of external radio frequency information entering the antenna will be reduced, and antenna performance will drop.

However, because the invention disposes the metal magnetic foil member outside this lead-facing areas opposite the antenna lead parts, radio waves and other external radio frequency information entering the electronic timepiece with an internal antenna through the watch crystal, which is positioned on the opposite side as the back cover, can travel between the back cover and the antenna and be received by the antenna, the radio waves can be received by the antenna without interference from the metal magnetic foil member, and the reception characteristics of the antenna can be improved. In addition, by using a metal magnetic foil member with sufficiently greater magnetic permeability than the back cover, the magnetic flux lines that are produced when the antenna receives the external radio frequency information can be sufficiently inducted through the metal magnetic foil member, and eddy current produced in the back cover can be suppressed.

In addition, compared with the configuration of the related art having an amorphous material compounded with a thick plastic sheet, the metal magnetic foil member can be formed as a foil that can be easily affixed by adhesion, thereby reducing the thickness. The thickness of the electronic timepiece with an internal antenna is thus not increased and a good design can be maintained.

In an electronic timepiece with an internal antenna according to another aspect of the invention, the metal magnetic foil member is preferably an amorphous foil member made from an amorphous metal.

The metal magnetic foil member in the invention may be formed using a cobalt-based amorphous foil made of Co—Fe—N—B—Si, for example.

Because amorphous metal has significantly higher magnetic permeability than metals such as titanium and brass that are used to manufacture the back cover, as well as lower conductivity than the metals used for the back cover, the magnetic flux lines produced in the antenna can be easily inducted to this amorphous foil member by disposing the amorphous foil member on the back cover. Fewer magnetic flux lines therefore pass through the back cover, and a drop in antenna performance can be prevented.

In an electronic timepiece with an internal antenna according to another aspect of the invention, the metal magnetic foil member is preferably positioned on the inside surface of the back cover outside the areas opposite both the lead parts and the coil winding part.

When the metal magnetic foil member is positioned in the area opposite the coil winding part adjacent to the lead parts, external radio frequency information that should pass near the areas opposite the coil winding part and enter the magnetic core from the lead parts is absorbed by the metal magnetic foil member. However, because the invention disposes the metal magnetic foil member outside the areas opposite both the lead parts and the coil winding part, the metal magnetic foil member does not interfere with external radio frequency information entering the electronic timepiece with an internal antenna, the magnetic flux lines produced by the antenna can be absorbed by the metal magnetic foil member with high magnetic permeability, and the occurrence of eddy current in the back cover can be suppressed. The antenna characteristics of the antenna can therefore be improved.

In an electronic timepiece with an internal antenna according to another aspect of the invention, the metal magnetic foil member is preferably positioned along the lengthwise direction of the antenna parallel to the coil winding part.

This aspect of the invention can desirably induct magnetic flux lines that are produced when external radio frequency information is received by the antenna into the metal magnetic foil member. More specifically, a magnetic path is formed parallel to the coil winding part from one end to the other end of the magnetic core as a result of external radio frequency information being received by the antenna. By disposing the metal magnetic foil member along the length of the antenna beside the coil winding part, a magnetic path is formed through the metal magnetic foil member, and most of the magnetic flux lines thus pass through the metal magnetic foil member. Fewer magnetic flux lines therefore pass through the back cover, and the eddy current produced by the magnetic flux lines can also be suppressed.

In an electronic timepiece with an internal antenna according to another aspect of the invention, the outside case preferably includes a substantially cylindrical casing to the bottom of which is affixed the back cover, the antenna is formed substantially in an arc along the inside surface of the casing, and the metal magnetic foil member is positioned substantially along the area opposite a chord joining both ends of the antenna on the inside surface of the back cover.

In this aspect of the invention the metal magnetic foil member is positioned inside an area opposite a fan-shaped region, or more specifically to a position on the inside surface of the back cover between the pair of lead-facing areas. If the antenna is formed in an arc, the magnetic flux lines produced when the external radio frequency information is received by the antenna pass from one lead part to the other lead part. At this time the magnetic flux lines are concentrated particularly in the area between the lead parts, that is, in the area near the chord connecting both ends of the antenna. Therefore, by disposing the metal magnetic foil member on the inside surface of the back cover in the area opposite this chord part, more magnetic flux lines can be inducted through the metal magnetic foil member, the magnetic flux lines passing through the back cover can be further reduced, and the production of eddy current in the back cover can be more effectively prevented. The antenna characteristics of the antenna can therefore be further improved.

In an electronic timepiece with an internal antenna according to another aspect of the invention, the outside case has a substantially cylindrically shaped body with an engaging part on the bottom end side for freely engaging and disengaging the back cover, the back cover can freely engage and disengage the engaging part of the body by rotating the back cover, and the metal magnetic foil member is substantially round and is positioned concentrically to the center of back cover rotation.

In this aspect of the invention the metal magnetic foil member is positioned in a substantially circular area in the center of the back cover. When the back cover is rotated and screwed into the body of the outside case, the position of the antenna relative to the back cover changes according to where rotation of the back cover starts and how far the back cover is turned. With the configuration of this aspect of the invention, however, the position of the metal magnetic foil member is set to the center of the back cover regardless of where rotation of the back cover starts and how far the back cover is turned. Good antenna characteristics can therefore be maintained regardless of how much the back cover is rotated.

In an electronic timepiece with an internal antenna according to another aspect of the invention, the metal magnetic foil member is affixed to the inside surface of the back cover by an intervening adhesive layer.

This aspect of the invention enables easily affixing the metal magnetic foil member using an adhesive layer, and can thus simplify installing the metal magnetic foil member. Furthermore, because the metal magnetic foil member is bonded by an adhesive, it is thinner than the plastic sheet of the related art, increasing the size of the electronic timepiece with an internal antenna can be prevented, and a good design can be maintained.

In an electronic timepiece with an internal antenna according to another aspect of the invention, the metal magnetic foil member comprises a plurality of stacked layers.

Because the metal magnetic foil member has a plurality of layers in this aspect of the invention, the thickness of the metal magnetic foil member is increased and more magnetic flux lines can therefore pass through. Thus fewer magnetic flux lines pass through the back cover, and the occurrence of eddy current in the back cover can be further suppressed. The antenna characteristics of the antenna can therefore be further improved.

In an electronic timepiece with an internal antenna according to another aspect of the invention, the metal magnetic foil member is positioned on the inside surface of the back cover through an intervening nonconductive member.

When there is a sufficient gap between the back cover and the antenna, this aspect of the invention enables disposing the metal magnetic foil member close to the antenna, improving magnetic induction, reducing the magnetic flux lines passing through the back cover, and improving the antenna characteristics. Problems such as magnetic flux flowing from the metal magnetic foil member to the back cover and producing eddy current in the back cover can also be prevented. In addition, because the nonconductive member functions as a buffer when the electronic timepiece with an internal antenna is subject to shock, stress from the back cover is not applied directly to the metal magnetic foil member, and damage to the metal magnetic foil member can be prevented.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a front view of a radio-controlled timepiece as an example of an electronic timepiece with an internal antenna according to a preferred embodiment of the invention.

FIG. 2 is a schematic plan view from the back cover side of the radio-controlled timepiece according to the first embodiment of the invention.

FIG. 3 is a schematic block diagram of the radio-controlled timepiece according to the first embodiment of the invention.

FIG. 4 is a schematic block diagram of the reception circuit unit of the radio-controlled timepiece according to the first embodiment of the invention.

FIG. 5 is a side section view through the thickness of the radio-controlled timepiece according to the first embodiment of the invention.

FIG. 6 is a plan view showing the configuration of the inside surface of the back cover in the first embodiment of the invention.

FIG. 7 is a table showing the antenna characteristics of the radio-controlled timepiece according to the first embodiment of the invention and the antenna characteristics of a radio-controlled timepiece according to the prior art.

FIG. 8 schematically shows signal reception in comparative example III.

FIG. 9 schematically shows signal reception in the first embodiment of the invention.

FIG. 10 shows the configuration of the back cover in a radio-controlled timepiece according to a second embodiment of the invention.

FIG. 11 is a side section view of a radio-controlled timepiece according to a third embodiment of the invention.

FIG. 12 is a side section view of a radio-controlled timepiece according to a fourth embodiment of the invention.

FIG. 13 shows the configuration of the inside surface of the back cover in a radio-controlled timepiece according to another embodiment of the invention.

FIG. 14 shows the configuration of the inside surface of the back cover in another embodiment of the invention, and a plan view of the amorphous foil member with a different width dimension.

FIG. 15 is a plan view of the amorphous foil member with yet another different width dimension.

FIG. 16 shows the configuration of the inside surface of the back cover in yet another embodiment of the invention, and is a plan view showing the amorphous foil member in FIG. 10 in an eccentric position.

FIG. 17 shows another embodiment in which the shape of the amorphous foil member shown in FIG. 16 is further deformed.

FIG. 18 shows the configuration of yet another embodiment, and is a plan view shown an example in which a plurality of amorphous foil members are positioned on the inside surface of the back cover.

FIG. 19 is a plan view showing a variation of the embodiment in FIG. 18 in which the amorphous foil members have different lengths.

FIG. 20 is a plan view showing a variation of the embodiment in FIG. 19 in which the amorphous foil members have different widths.

### DESCRIPTION OF THE PREFERRED EMBODIMENTS

### Embodiment 1

Preferred embodiments of the present invention are described below with reference to the accompanying figures. Note that parts that are functionally the same as parts that have already been described are identified by the same reference numerals, and further description thereof is omitted.

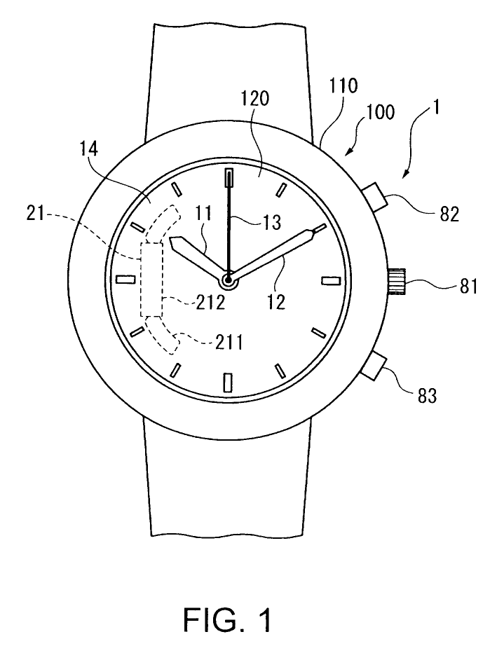

FIG. 1 is a front view of a radio-controlled timepiece as an example of an electronic timepiece with an internal antenna according to a preferred embodiment of the invention.

As shown in FIG. 1, a radio-controlled timepiece 1 according to a preferred embodiment of the invention is an analog timepiece with hands 11, 12, and 13 and a dial 14, and is a timepiece that can receive long-wave standard time signals as external radio frequency information containing time information, and can correct the positions indicated by the hands 11, 12, and 13 based on the received time information.

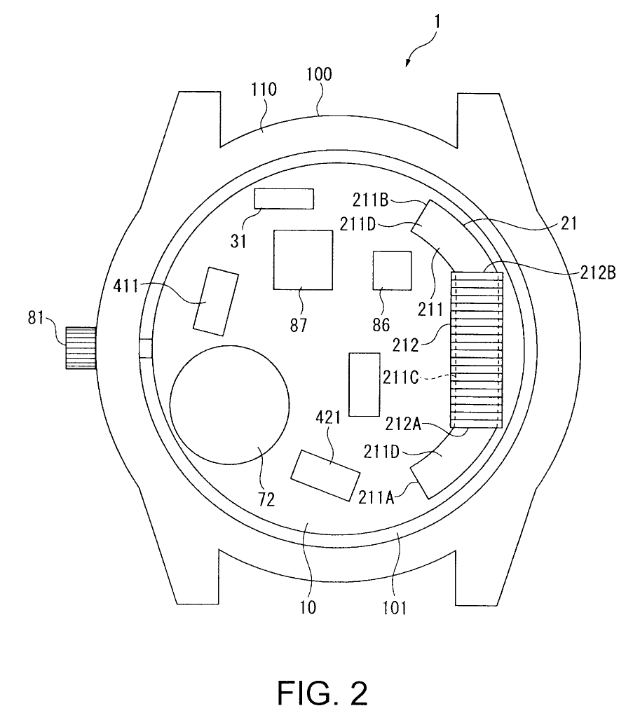

The radio-controlled timepiece 1 includes the hands 11, 12, and 13, the dial 14, a module 10 including components for controlling an antenna 21 that receives the standard time signals and driving the hands 11, 12, and 13, and an external case 100 that houses within the hands 11, 12, and 13, dial 14, and module 10 (see FIG. 2).

### Module Configuration

The module 10 used in the radio-controlled timepiece 1 is described below with reference to FIG. 2 to FIG. 5.

FIG. 2 is a schematic plan view from the back cover side of the radio-controlled timepiece according to the first embodiment of the invention.

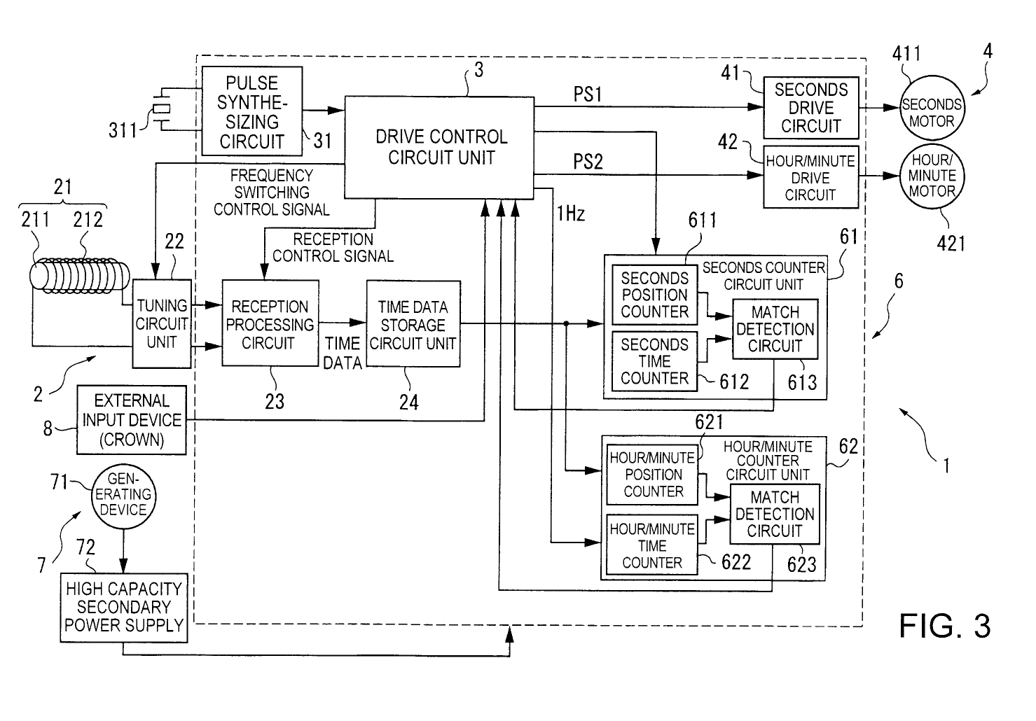

FIG. 3 is a schematic block diagram of the radio-controlled timepiece according to the first embodiment of the invention.

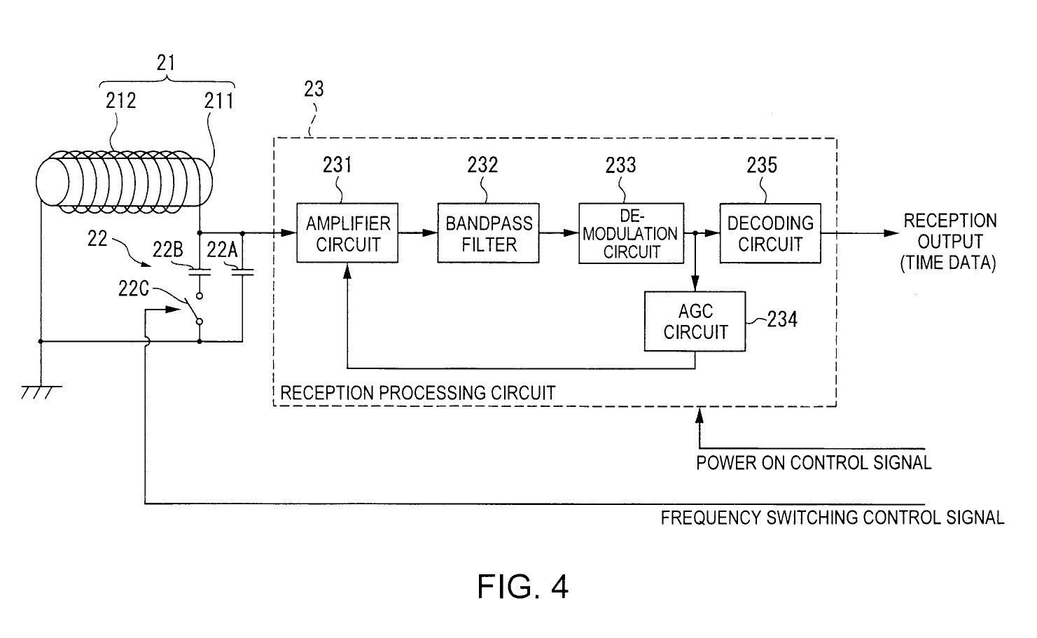

FIG. 4 is a schematic block diagram of the reception circuit unit of the radio-controlled timepiece according to the first embodiment of the invention.

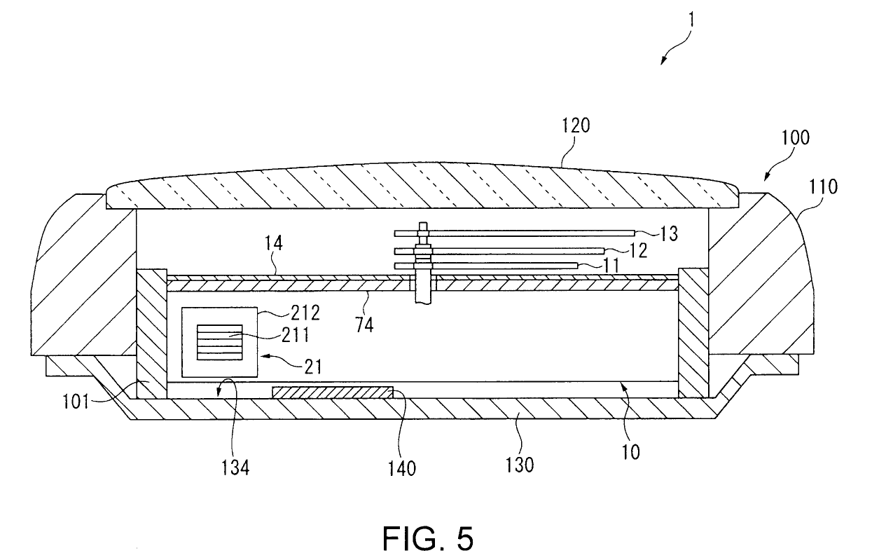

FIG. 5 is a side section view through the thickness of the radio-controlled timepiece according to the first embodiment of the invention.

The module 10 has a plastic module spacer 101 that is round when seen in plan view. A plurality of bosses (not shown in the figure) that contact the inside circumference surface of the external case 100 are formed projecting radially from the side of the module spacer 101, and are positioned along the inside surface of the external case 100.

A space equal to the amount that the bosses protrude from the module spacer 101 is formed around the entire circumference between the side surface of the module spacer 101 and the inside surface of the external case 100 at the parts of the side of the module spacer 101 (see FIG. 5) where the bosses are not formed.

The module 10 is held in position when placed inside the external case 100 as a result of the bosses on the module spacer 101 contacting the inside surface of the external case 100.

Components including a circuit board not shown, the movement, and a high capacity secondary power supply (storage battery) 72 are positioned on the inside of the module spacer 101 of the module 10. The circuit board is populated with devices including a reception chip 86, a CPU 87, and a reference oscillator 311 (see FIG. 3). The movement includes motors 411 and 421 that are part of the drive unit 4, and a wheel train. The module 10 also includes the antenna 21 for receiving signals at a location near the external case 100.

As also shown in FIG. 3, the circuit board assembled in the module includes a reception processor 2 for processing the received signals, a drive control circuit unit 3, a drive unit 4 for driving the hands, and a counter unit 6 for counting the time.

The reception processor 2 includes the antenna 21 for receiving signals, a tuning circuit unit 22 composed of a capacitor and other components for tuning to the signal received by the antenna 21, a reception processing circuit 23 that processes information received by the antenna 21, and a time data storage circuit unit 24 that stores the time data processed by the reception processing circuit 23.

As shown in FIG. 4, the tuning circuit unit 22 includes two capacitors 22A and 22B parallel connected to the antenna 21 with one capacitor 22B connected to the antenna 21 through a switch 22C.

The frequency of the signal received by the antenna 21 can be changed by a frequency switching control signal that is output from the drive control circuit unit 3 and causes the switch 22C to turn on or off. This enables switching and receiving long-wave standard time signals of two different frequencies, such as the 40-kHz signals that are transmitted by the standard time signal transmission station at Mount Otakadoya (for eastern Japan) and the 60-kHz signals that are transmitted by the transmission station at Mount Hagane (for western Japan) in Japan.

As also shown in FIG. 4, the reception processing circuit 23 includes an amplifier circuit 231, a bandpass filter 232, a demodulation circuit 233, an automatic gain control (AGC) circuit 234, and a decoding circuit 235.

The amplifier circuit 231 amplifies the long-wave standard time signal received by the antenna 21. The bandpass filter 232 extracts the desired frequency component from the amplified long-wave standard time signal. The demodulation circuit 233 smoothes and demodulates the extracted long-wave standard time signal. The AGC circuit 234 controls the gain of the amplifier circuit 231 to keep the reception level of the long-wave standard time signal constant. The decoding circuit 235 then decodes and outputs the demodulated long-wave standard time signal.

The time data that is received and signal processed by the reception processing circuit 23 is output to and stored by the time data storage circuit unit 24 as shown in FIG. 3.

The reception processing circuit 23 starts receiving time information based on a reception control signal output from the drive control circuit unit 3 according to a predetermined reception schedule or when reception is started unconditionally by operation of an external input device 8.

As shown in FIG. 3, a pulse signal from the pulse synthesizing circuit 31 is input to the drive control circuit unit 3. The pulse synthesizing circuit 31 frequency divides a reference pulse from the reference oscillator 311, such as a crystal oscillator, to generate a clock pulse, and generates pulse signals of different pulse widths and timing from the reference pulse. The reference oscillator 311 is connected to the CPU 87 and produces a clock signal for the circuitry, and is located away from the antenna 21 because the clock signal frequency is near the frequency of the received long-wave standard time signal and produces noise if mixed with the signals received by the antenna 21.

The drive control circuit unit 3 outputs a seconds drive pulse signal PS1 that is output once a second for driving the second hand, and an hour/minute drive pulse signal PS2 that is output once a minute for driving the hour and minute hands, to the seconds drive circuit 41 and hour/minute drive circuit 42 to drive the hands. More specifically, the drive circuits 41 and 42 drive the seconds motor 411 and hour/minute motor 421, which are stepping motors that are driven by pulse signals from the corresponding drive circuits 41 and 42, and thus drive the second hand and the minute and hour hands that are connected to the motors 411 and 421. The hands, dial, motors 411 and 421, and drive circuits 41 and 42 thus form a time display for displaying the time. Note that the time display may also drive the hour hand, minute hand, and second hand using a single motor.

The counter unit 6 includes a seconds counter circuit unit 61 for counting the seconds, and a hour/minute counter circuit unit 62 for counting the hour and minute.

The seconds counter circuit unit 61 includes a seconds position counter 611, a seconds time counter 612, and a match detection circuit 613. The seconds position counter 611 and seconds time counter 612 are both counters that loop at the 60 count, that is, every 60 seconds when a 1-Hz signal is input. The seconds position counter 611 counts the drive pulse signal (seconds drive pulse signal PS1) that is supplied from the drive control circuit unit 3 to the seconds drive circuit 41. More specifically, the position that is pointed to by the second hand is counted by counting the drive pulse signal that drives the second hand.

The seconds time counter 612 normally counts the 1-Hz reference pulse (clock pulse) that is output from the drive control circuit unit 3. If time data is received by the reception processor 2, the counter is adjusted to match the seconds value in the received time data.

The hour/minute counter circuit unit 62 similarly includes an hour/minute position counter 621, an hour/minute time counter 622, and a match detection circuit 623. The hour/minute position counter 621 and hour/minute time counter 622 are both counters that loop when signals equal to 24 hours are input. The hour/minute position counter 621 counts the drive pulse signal (hour/minute drive pulse signal PS2) that is supplied from the drive control circuit unit 3 to the hour/minute drive circuit 42, and counts the positions that are pointed to by the hour hand and minute hand.

The hour/minute time counter 622 normally counts a 1-Hz pulse signal (clock pulse) that is output from the drive control circuit unit 3. More precisely, the hour/minute time counter 622 increments 1 when sixty 1-Hz pulses are counted. If time data is received by the reception processor 2, the counter is adjusted to match the hour and minute values in the received time data.

The match detection circuits 613 and 623 detect if the counts of the position counters 611 and 621 and the counts of the time counters 612 and 622 match, and output a detection signal indicating whether or not the counts match to the drive control circuit unit 3.

If a mismatch signal is input from the match detection circuits 613 and 623, the drive control circuit unit 3 continues outputting the drive pulse signals PS1 and PS2 until a match signal is input. If the 1-Hz reference signal from the drive control circuit unit 3 causes the count of the time counters 612 and 622 to change and a mismatch with the position counters 611 and 621 occurs during the normal timekeeping operation of the movement, the drive pulse signals PS1 and PS2 are output so that the hands move and the position counters 611 and 621 again match the time counters 612 and 622. This operation keeps repeating and the movement is controlled as usual.

When time counters 612 and 622 are adjusted to the received time data, the drive pulse signals PS1 and PS2 are output continuously and the hands are moved quickly and adjusted to the correct time until the counts of the position counters 611 and 621 and the time counters 612 and 622 match.

A power supply 7 includes a generating device 71 and the high capacity secondary power supply 72. The generating device 71 is a power generator formed by a self-winding generator or a solar cell (solar generator). The high capacity secondary power supply 72 stores power generated by the generating device 71. The high capacity secondary power supply 72 may be a lithium ion battery or other type of secondary cell. A primary cell such as a silver oxide battery may also be used as the power supply 7. Note that because the high capacity secondary power supply 72 has a stainless steel case, it is separated from the antenna 21 at a location near 3:00 o'clock as shown in FIG. 2 in order to suppress its influence on antenna characteristics.

The external input device 8 used as an external input has a crown and is used to set the time and start reception, for example.

The antenna 21 is located near the 9:00 o'clock position of the timepiece dial conforming substantially to the inside surface of the module spacer 101.

The antenna 21 has a magnetic core 211 and a coil 212 wound around the magnetic core 211.

The magnetic core 211 is substantially square in section as shown in FIG. 5. As shown in FIG. 2, the magnetic core 211 has a straight coil winding part 211C around which the coil 212 is wound, and lead parts 211D that extend from both ends of the coil winding part 211C conforming substantially to the inside circumference of the casing 110 that forms the body of the external case 100.

The magnetic core 211 is made by adhesively stacking approximately 10 to 30 foil layers stamped or etched from a cobalt-based amorphous foil sheet (such as amorphous foil containing at least 50 wt % Co), and heat treating the foil layers by annealing, for example, to stabilize the magnetic characteristics. The magnetic core 211 is thus formed by stacking flat amorphous foil layers in the thickness direction of the timepiece. The magnetic core 211 is not limited to a layered amorphous foil construction, and may be made using a ferrite material that is shaped using a mold and then heat treated.

The coil 212 must have an inductance of approximately 10 mH to receive long-wave standard time signals in the 40-77.5 kHz range. In this embodiment of the invention the coil 212 was made by wrapping several hundred winds of an approximately 0.1 μm diameter polyurethane-coated magnet wire. The coil 212 is wound to the coil winding part 211C of the magnetic core 211 between the first coil-end part 212A of the coil 212 at a predetermined distance from one end of the magnetic core 211 (the first core end 211A) and the second coil-end part 212B of the coil at a predetermined distance from the other end of the magnetic core 211 (second core end 211B) with the coil 212 winding around the surface of the circumference around the lengthwise axis of the magnetic core 211.

The antenna 21 and the reception chip 86 are connected by two leads. More specifically, the antenna 21 and the reception chip 86 are electrically connected by soldering the coil 212 at an end part of the antenna to the circuit board. This enables outputting the standard time signal received by the antenna 21 to the reception processor 2. Note that the electrical connection may alternatively be made by attaching a flexible circuit made of polyimide, for example, to the antenna 21, and fastening this circuit to the circuit board with a screw.

### Configuration of the External Case

The configuration of the external case 100 of the radio-controlled timepiece 1 is described next.

As shown in FIG. 2 and FIG. 5, the external case 100 includes the casing 110 as the main body, a crystal 120 attached to the dial side of the casing 110, and a metal back cover 130 attached to the back side of the casing 110 (the side on the bottom in FIG. 5).

The casing 110 may be made of metal, such as stainless steel, brass, or titanium. The casing 110 in this embodiment of the invention is substantially cylindrical and the inside surface is substantially round when seen in plan view.

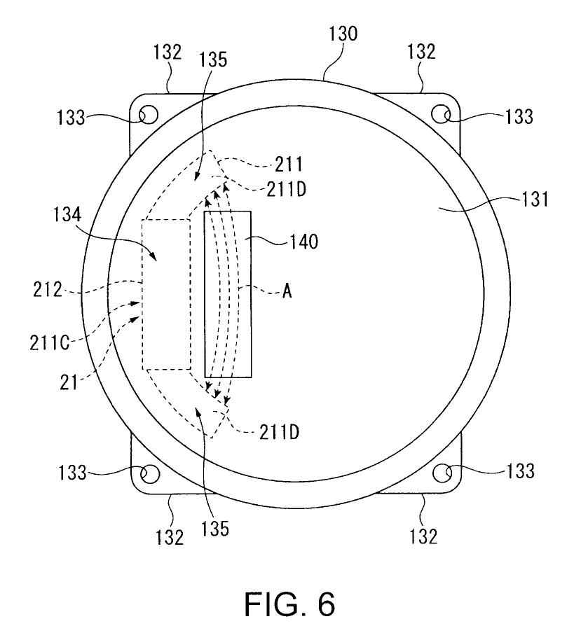

The back cover 130 is fastened to the bottom of the casing 110 as described above by screws, for example. FIG. 6 is a plan view showing the configuration of the inside surface of the back cover in the first embodiment of the invention.

As shown in FIG. 6 the back cover 130 includes a disc-shaped round part 131 that is slightly larger in diameter than the inside surface of the casing 110, and four screw flanges 132 projecting to the outside radially from the round part 131. Each screw flange 132 has a screw hole 133 through which a screw can pass. The back cover 130 is positioned to a predetermined position on the bottom of the casing 110, and then fastened to the casing 110 by screws screwed through the screw hole 133 in each of the screw flanges 132 into the bottom of the casing 110.

As shown in FIG. 6, an amorphous foil member 140 is affixed as a metal magnetic foil member to the inside surface of the back cover 130 (the surface facing the module 10) by an intervening adhesive layer such as an adhesive film. More specifically, this amorphous foil member 140 is positioned so that it is separated a predetermined distance from the antenna-facing area 134 of the inside surface of the back cover 130 opposite the antenna 21, that is, a position where there is no overlap with the antenna 21 when seen in plan view. In addition, the amorphous foil member 140 is long, positioned beside the coil winding part 211C of the antenna 21 parallel to the lengthwise direction of the coil winding part 211C and between the pair of lead-facing areas 135 on the inside surface of the back cover 130 opposite the pair of lead parts 211D.

This amorphous foil member 140 is a cobalt-based amorphous foil made of Co—Fe—N—B—Si, for example. The relative magnetic permeability of an amorphous foil member 140 made of a Co—Fe—N—B—Si cobalt-based amorphous foil, for example, is 20,000. For comparison, the relative magnetic permeability of a back cover 130 made of stainless steel is 1.4, 1.0 when brass is used, and 1.0001 when titanium is used. The magnetic permeability of the amorphous foil member 140 is thus significantly greater than the metal from which the back cover 130 is made.

When radio signals are received by the antenna 21, a secondary magnetic path (indicated by arrow A in FIG. 6) through which magnetic flux lines flow is formed from one of the lead parts 211D to the other lead part 211D as shown in FIG. 6. Because the magnetic permeability of the amorphous foil member 140 is significantly greater than the metal used in the back cover, the magnetic flux lines pass through the inside of the amorphous foil member 140 instead of through the back cover. In addition, because the antenna 21 is formed substantially in an arc along the inside circumference surface of the casing 110, many of the magnetic flux lines travel on the straight line (chord) from one lead part 211D to the other lead part 211D.

Because the amorphous foil member 140 is positioned between the pair of lead-facing areas 135 as described above, the magnetic flux lines passing on a line between the lead parts 211D are inducted by the amorphous foil member 140. Because most of the magnetic flux lines are thus inducted by the amorphous foil member 140, fewer magnetic flux lines pass through the back cover 130. In addition, because the conductivity of the amorphous foil member 140 is lower than the conductivity of the metal used in the back cover 130, less eddy current is produced by the magnetic flux lines passing through the amorphous foil member 140 than when the magnetic flux lines pass through the back cover 130.

In addition, the amorphous anisotropy of the amorphous foil member 140 is substantially aligned with the longitudinal axis, that is, substantially parallel to the lengthwise axis of the coil winding part 211C of the antenna 21. Substantially constant anisotropy can be imparted to the amorphous foil member 140 by, for example, drawing a molten amorphous material quickly in one direction using rollers to form the amorphous foil member 140. The amorphous foil member 140 thus formed is then bonded to the inside surface of the back cover 130 so that the drawing direction of the rollers is substantially parallel to the coil winding part 211C.

### Comparison of Antenna Reception Sensitivity In Radio-Controlled Timepieces

The antenna characteristics of an antenna 21 made from an amorphous foil member 140 as described above are described next.

The antenna characteristics of the radio-controlled timepiece 1 in this embodiment of the invention were measured using the tests described below.

A radio-controlled timepiece 1 having the amorphous foil member 140 positioned substantially parallel to the coil winding part 211C at a position separated a predetermined distance from the antenna-facing area 134 on the inside surface of the back cover 130 according to the first embodiment described above was used as the radio-controlled timepiece 1, and a long-wave standard time signal was received through the antenna 21. The inductance (L) of the antenna 21, the Q factor (Q value) of the antenna 21, and the attenuation of reception sensitivity were measured (test sample I).

For comparison, a radio-controlled timepiece 1 in which the amorphous foil member 140 positioned on the back cover 130 was removed (comparison sample II), and a radio-controlled timepiece 1 in which the amorphous foil member 140 was positioned in the antenna-facing area 134 at the inside surface of the back cover 130 (comparison sample III), were also prepared, and the L, Q, and reception sensitivity attenuation were measured when a long-wave standard time signal was received in the same way as test sample I.

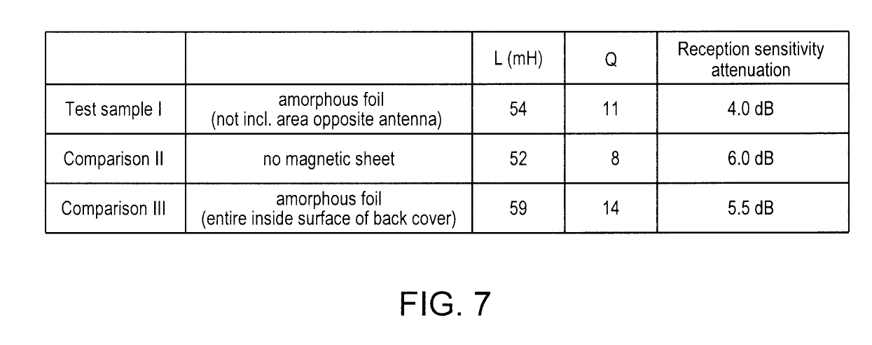

The results of these measurements from the test sample I and comparison samples II and III are shown in FIG. 7.

Referring to FIG. 7, the magnetic flux lines produced in the antenna 21 flow through the back cover 130 and produce eddy current in comparison sample II because a magnetic member such as the amorphous foil member 140 is not positioned on the back cover 130.

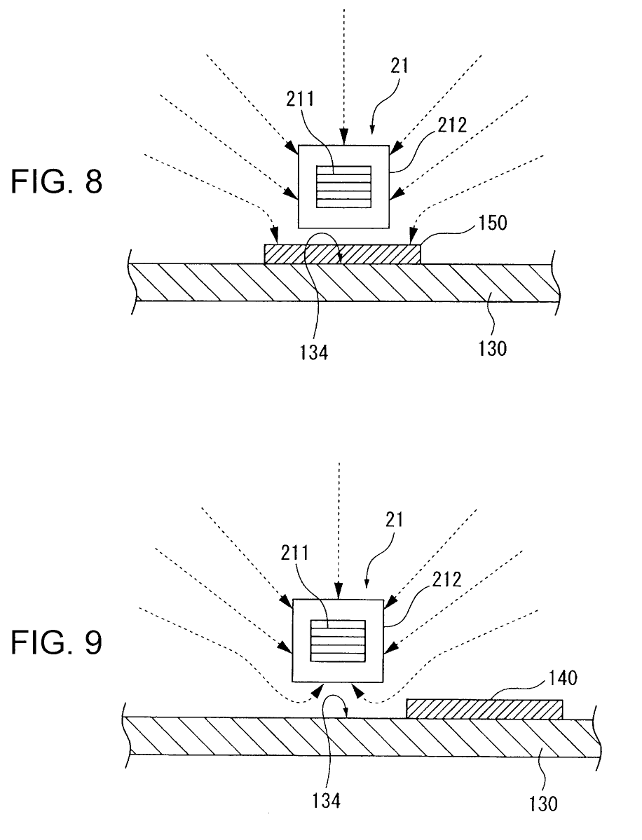

FIG. 8 schematically describes radio signal reception in comparison sample III. In comparison sample III as shown in FIG. 8, part of the radio signals input to the antenna 21 are absorbed by the amorphous foil member 150 formed in the antenna-facing area 134. Production of eddy current in the back cover 130 can therefore be desirably prevented and the Q increased, but attenuation of the reception sensitivity of the antenna 21 increases because radio wave absorption by the amorphous foil member 150 reduces the radio waves that can enter the antenna 21.

FIG. 9 schematically describes radio wave reception in the first embodiment of the invention.

Because unlike comparison samples II and III the radio-controlled timepiece 1 of the invention does not have the amorphous foil member 140, a ferromagnetic member, in the antenna-facing area 134, radio waves entering the antenna 21 are not absorbed by the amorphous foil member 140 as shown in FIG. 9, and there is no interference with signal reception. Therefore, while the Q and L values are lower than in comparison sample III, there is an increase in the strength of the signals entering the antenna 21, less attenuation of the reception sensitivity, and as a result better antenna characteristics than in comparison samples II and III.

### Effect of the Radio-Controlled Timepiece

As described above, the radio-controlled timepiece 1 according to a preferred embodiment of the invention has an amorphous foil member 140 positioned on the inside surface of the back cover 130 at a position outside of the lead-facing areas 135 that are opposite the lead parts 211D of the antenna 21.

As a result, radio waves that should enter the antenna 21 are not absorbed by the ferromagnetic amorphous foil member 140, and radio waves can be efficiently received from between the antenna 21 and the back cover 130. Furthermore, because the magnetic permeability of the amorphous foil member 140 is significantly greater than the magnetic permeability of the back cover 130, most of the magnetic flux lines that are produced when signals are received by the antenna 21 pass through the amorphous foil member 140 even though the amorphous foil member 140 is separated from the antenna-facing area 134. The eddy current produced by magnetic flux lines passing through the back cover 130 can thus be sufficiently reduced. Because eddy current production can thus be suppressed while not interfering with the radio waves received by the antenna 21, an antenna 21 with good antenna characteristics can be achieved by utilizing a simple construction.

In addition, the amorphous foil member 140 is positioned on the inside surface of the back cover 130 at a position where it does not overlap the area opposite the lead parts 211D and the coil winding part 211C, that is, the antenna-facing area 134 that is opposite all of the antenna 21.

The amorphous foil member 140 therefore does not interfere with radio waves entering the lead parts 211D or the coil winding part 211C adjacent to the lead parts 211D of the magnetic core 211, and radio waves travelling from the coil winding part 211C around to the lead parts 211D are also desirably received by the antenna 21. The strength of the signals received by the antenna 21 thus improves and better antenna performance can be achieved.

The amorphous foil member 140 is also positioned on the back cover 130 parallel to the coil winding part 211C.

This configuration disposes the amorphous foil member 140 on the magnetic path formed from one end to the other end of the magnetic core 211 of the antenna 21, making it easier for magnetic flux lines produced in the antenna 21 to enter the amorphous foil member 140 and thus reducing the penetration of magnetic flux lines to the back cover 130. Eddy current in the back cover 130 can thus be well prevented, and good antenna characteristics can be achieved.

The amorphous foil member 140 is also positioned between the pair of lead-facing areas. As a result, the magnetic flux lines leaving one lead part 211D can travel to the other lead part 211D by simply passing through the substantially straight amorphous foil member 140. More specifically, because the amorphous foil member 140 is positioned in an area facing a line segment through the shortest distance between the lead parts 211D, magnetic flux lines produced when radio waves are received by the antenna 21 can pass more easily through the amorphous foil member 140, thus further reducing the magnetic flux lines passing through the back cover 130. The occurrence of magnetic flux lines in the back cover 130 can thus be more efficiently suppressed, and good antenna characteristics can be achieved.

The anisotropy of the amorphous foil member 140 is formed lengthwise, that is, in the direction substantially parallel to the axial direction of the coil winding part 211C. More specifically, the orientation of secondary magnetic path A of the antenna 21 and the anisotropy of the amorphous foil member 140 match. By thus inducting most of the magnetic flux lines through the amorphous foil member 140, the magnetic flux lines penetrating the back cover 130 can be reduced. Production of eddy current in the back cover 130 can therefore be effectively suppressed.

Furthermore, because the amorphous foil member 140 is foil and the amorphous foil member is fastened in place by adhesive, the amorphous foil member 140 can be formed with minimal thickness and the gap between the back cover 130 and the module 10 can be reduced. The thickness of the radio-controlled timepiece 1 is thus not increased and a pleasing design can be achieved.

Furthermore, because an amorphous foil member with significantly greater magnetic permeability than the back cover 130 is used as the metal magnetic foil member, the magnetic flux lines produced in the antenna 21 can be efficiently inducted into the amorphous foil member 140, and production of eddy current in the back cover 130 can be more effectively prevented. Better antenna performance can thus be achieved.

### Embodiment 2

A second embodiment of the invention is described next with reference to the accompanying figures. Note that in the figures and embodiments described below parts that are the same as in the radio-controlled timepiece 1 according to the first embodiment described above are identified by the same reference numerals, and further description thereof is simplified or omitted.

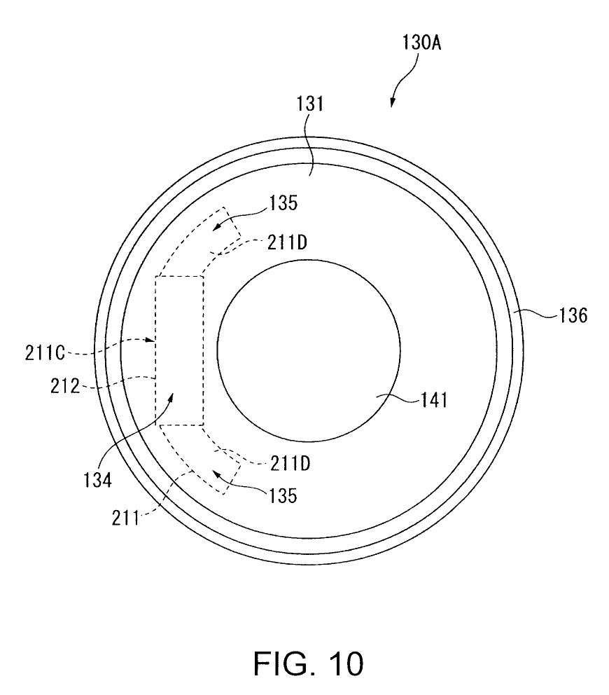

FIG. 10 schematically describes the configuration of the back cover of a radio-controlled timepiece according to a second embodiment of the invention.

This second embodiment of the invention is a variation of the configuration of the back cover 130 in the first embodiment.

More specifically, the back cover 130A of the radio-controlled timepiece 1 according to this second embodiment of the invention includes a substantially disk-shaped round part 131, and a basically cylindrical screw part 136 having a male screw thread formed on the outside surface along the edge of the surface of the round part 131 facing the casing 110.

A female thread part not shown is formed on the bottom end (back cover side) of the inside surface of the casing 110. The back cover 130A can thus be freely attached to and removed from the casing 110 by threading the screw part 136 into this female thread part.

An amorphous foil member 141 is positioned concentrically to the round part 131 on the inside surface of the back cover 130A opposite the round part 131 (on the surface facing the module 10). As shown in FIG. 10, the radius of this amorphous foil member 141 is set so that the amorphous foil member 141 does not overlap the antenna-facing area 134 opposite the antenna 21. This amorphous foil member 141 is made from a cobalt-based amorphous foil member with significantly higher magnetic permeability than the metal used to manufacture the back cover 130A, similarly to the amorphous foil member 140 in the first embodiment.

### Effect of the Second Embodiment

A round amorphous foil member 141 with a radius that does not overlap the antenna-facing area 134 is formed concentrically to the round part 131 of the inside surface of the back cover 130A in a radio-controlled timepiece 1 according to the second embodiment of the invention.

As a result, when the back cover 130A is screwed together with the casing 110, the position of the amorphous foil member 141 does not change regardless of how far the back cover 130A is turned or where rotation starts, and the amorphous foil member 141 is always positioned concentrically to the back cover 130A at a position not overlapping the antenna-facing area 134. The amorphous foil member 141 can therefore be easily placed on the back cover 130A at a position that is not opposite the antenna 21, and manufacturability is thus improved.

In addition, even though the amorphous foil member 141 is round, magnetic flux lines from the antenna 21 can be favorably inducted in the same way as in the radio-controlled timepiece 1 according to the foregoing first embodiment, eddy currents in the back cover 130 can be suppressed, an antenna 21 shield effect can be avoided, and good antenna characteristics can be achieved.

### Embodiment 3

A radio-controlled timepiece according to a third embodiment of the invention is described next with reference to the accompanying figures.

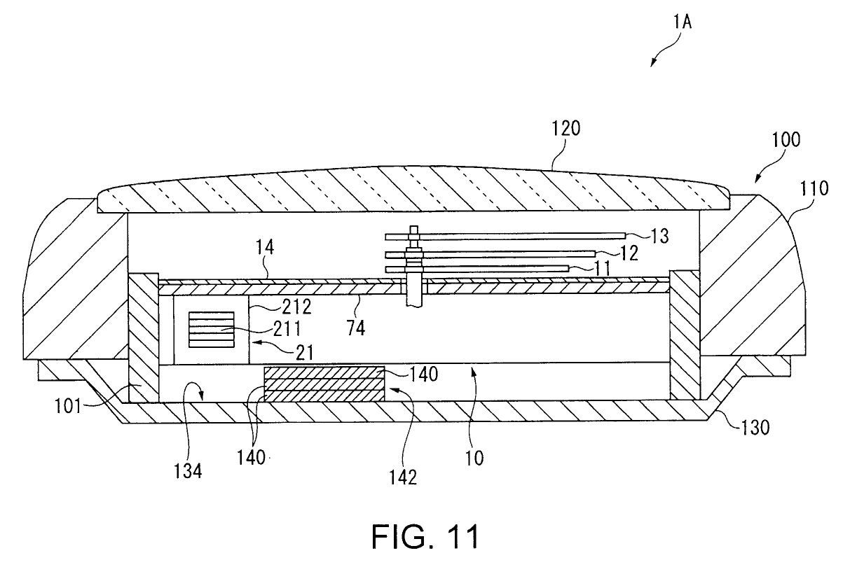

FIG. 11 is a side section view of a radio-controlled timepiece according to a third embodiment of the invention.

The radio-controlled timepiece 1 according to the first embodiment described above has a single amorphous foil member 140 adhesively affixed to the back cover 130. In the radio-controlled timepiece 1A according to this third embodiment of the invention, however, a plurality of amorphous foil members 140 are stacked together on the back cover 130 to form an amorphous foil layer 142. The position where this amorphous foil layer 142 is formed is the same site where the amorphous foil member 140 is positioned in the radio-controlled timepiece 1 according to the foregoing first embodiment, that is, a position where there is no overlap with the antenna-facing area 134 and the amorphous foil layer 142 is parallel to the coil winding part 211C of the antenna 21.

There is also a gap of approximately 1 mm, for example, between the top of the amorphous foil layer 142 (the surface facing the module 10) and the module 10.

### Effect of a Radio-Controlled Timepiece According to a Third Embodiment of the Invention

As described above, a amorphous foil layer 142 composed of stacked amorphous foil members 140 is formed in the radio-controlled timepiece 1A according to this third embodiment of the invention at a position on the inside surface of the back cover 130 that does not overlap the antenna-facing area 134 opposite the antenna 21.

The thickness of the amorphous foil layer 142 is thus greater than a configuration having a single affixed amorphous foil member 140, and the area through which the magnetic flux lines pass also increases. The magnetism gathering efficiency of the amorphous foil layer 142 therefore improves and more magnetic flux lines can pass through the amorphous foil layer 142. The magnetic flux lines passing through the back cover 130 can thus be further reduced, and eddy current production can be more efficiently suppressed.

A small gap is also provided between the top of the amorphous foil layer 142 and the module 10. Even if the timepiece is subject to vibration caused by impact, for example, this gap ensures that the amorphous foil layer 142 will not touch the module 10, and damage to the amorphous foil layer 142 can be prevented.

### Embodiment 4

A radio-controlled timepiece according to a fourth embodiment of the invention is described next with reference to the accompanying figures.

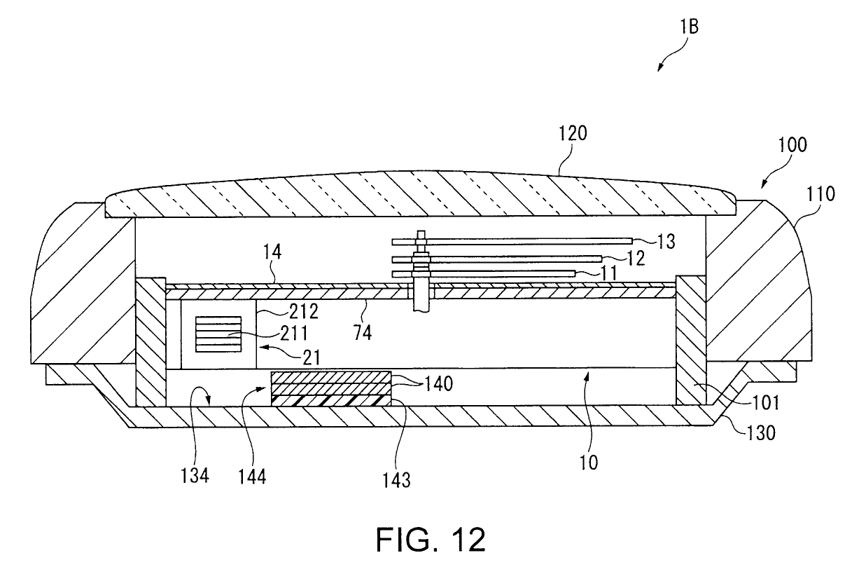

FIG. 12 is a side section view of a radio-controlled timepiece according to a fourth embodiment of the invention.

The radio-controlled timepiece 1 according to the third embodiment described above has an amorphous foil layer 142 formed by stacking a plurality of amorphous foil members 140 directly on the back cover 130. In a radio-controlled timepiece 1B according to this fourth embodiment of the invention, a plastic sheet 143 is affixed as a nonconductive member on the inside surface of the back cover 130, and a plurality of amorphous foil members 140 are stacked on this plastic sheet to form an amorphous foil layer 144.

The position where this amorphous foil layer 144 is formed is the same site as the amorphous foil members 140 in the first and third embodiments, that is, a position where there is no overlap with the antenna-facing area 134 and parallel to the coil winding part 211C of the antenna 21.

Note that the plastic sheet is not limited to being affixed at the position where the amorphous foil members 140 are stacked, and may be applied over the entire inside surface of the back cover 130, for example.

### Effect of the Fourth Embodiment of the Invention

In the radio-controlled timepiece 1B according to this fourth embodiment of the invention, a plastic sheet 143 is affixed to the inside surface of the back cover 130, and a plurality of amorphous foil members 140 are stacked on this plastic sheet 143 to form an amorphous foil layer 144.

The magnetic flux lines produced when signals are received by the antenna are thus impeded from flowing from the amorphous foil member 140 to the back cover 130, and the occurrence of eddy current in the back cover 130 can thus be more effectively suppressed. Furthermore, if the radio-controlled timepiece 1B is subject to shock, the plastic sheet 143 acts as a damper so that stress is not applied directly from the back cover 130 to the amorphous foil member 140. As a result, impact damage to the amorphous foil member 140 can also be prevented.

### Other Embodiments

The invention is not limited to the embodiments described above, and other modifications and improvements achieving the same effect as the invention are included in the scope of this invention.

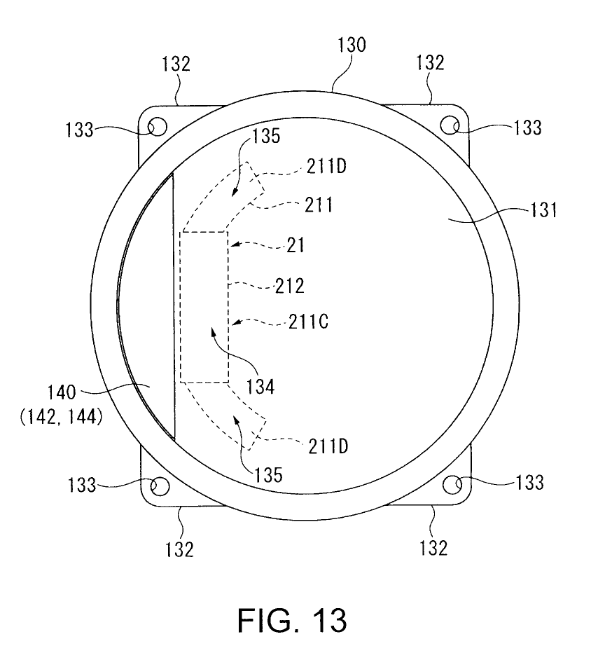

For example, in the first, third, and fourth embodiments the amorphous foil member 140 and the amorphous foil layers 142 and 144 are positioned offset towards the center of the back cover 130 from the antenna-facing area 134 opposite the antenna 21, but they may be positioned such as shown in FIG. 13.

More specifically, as shown in FIG. 13, the amorphous foil member 140 may be positioned away from the antenna-facing area 134 near the perimeter of the back cover 130. FIG. 13 shows an example having the amorphous foil member 140, but an amorphous foil layer 142, 144 such as described in the third and fourth embodiments may be used instead.

Further alternatively, the amorphous foil member 140 or amorphous foil layer 142, 144 may be positioned over the entire surface of the back cover 130 except in the antenna-facing area 134.

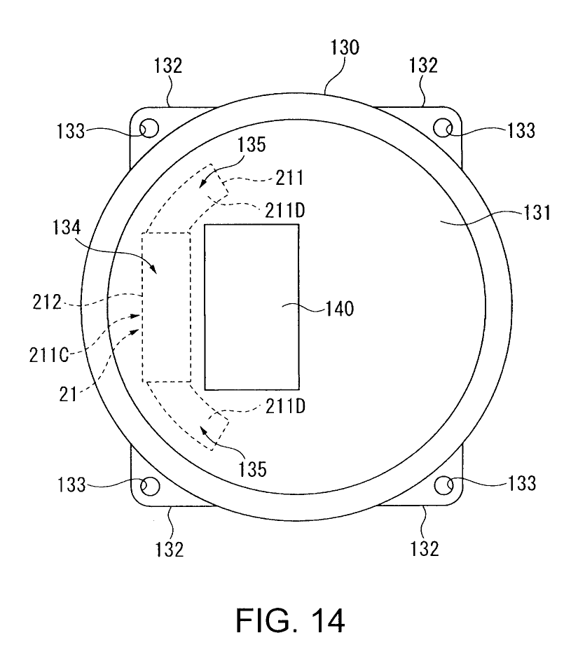

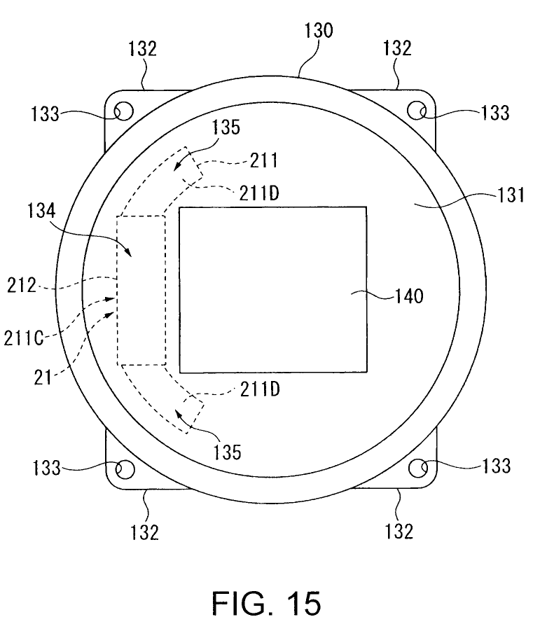

The foregoing embodiments are described having a long amorphous foil member 140 fixed in a position through the secondary magnetic path A formed between the pair of lead parts 211D in FIG. 6, but the invention is not limited to this shape. More specifically, an amorphous foil member 140 formed with greater width in the direction perpendicular to the long axis as shown in FIG. 14 may be used, or this width may be further increased and the amorphous foil member 140 may be substantially square as shown in FIG. 15.

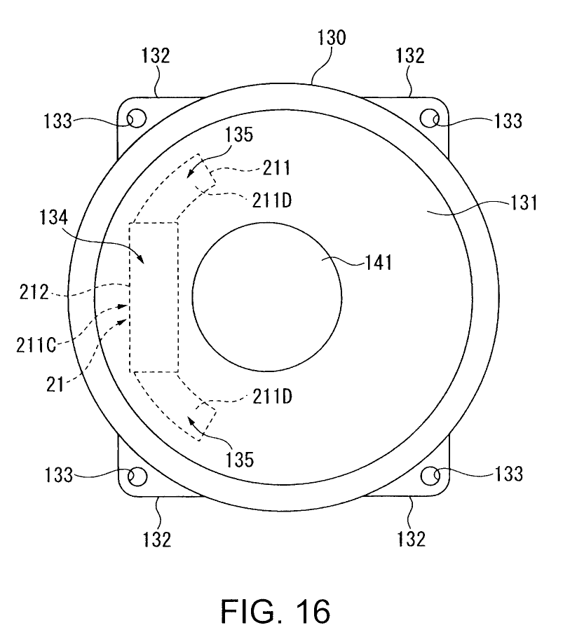

In the embodiment shown in FIG. 10, a round amorphous foil member 141 is positioned in the center of the back cover 130, but the center point of the amorphous foil member 141 may alternatively be located eccentrically to the center of the back cover 130 as shown in FIG. 16.

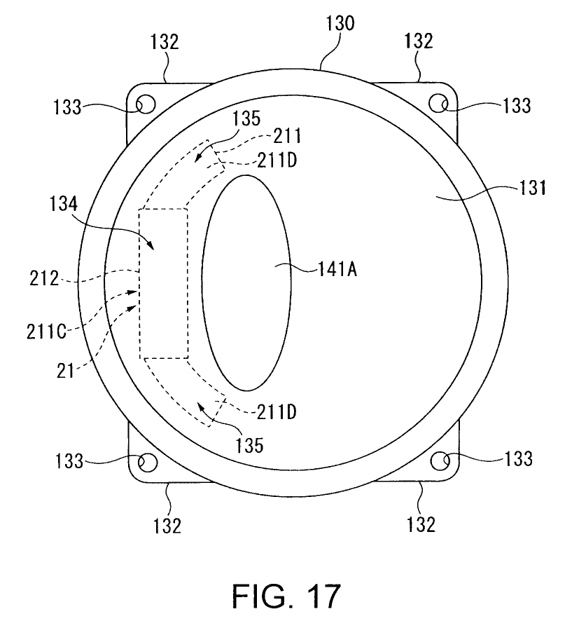

Yet further alternatively, an elliptically shaped amorphous foil member 141A such as shown in FIG. 17 may be used instead of a round amorphous foil member 141. This amorphous foil member 141A may be placed anywhere other than a position opposite the antenna 21 of the back cover 130, but by positioning the amorphous foil member 141A along the path between the pair of lead parts 211D as shown in FIG. 17, magnetic flux lines flowing through the secondary magnetic path between the lead parts 211D can be desirably inducted through the amorphous foil member 141A and antenna characteristics can be improved.

The variations shown in FIG. 14 to FIG. 17 above are described having a single amorphous foil member affixed to the inside surface of the back cover 130, but the invention is not so limited.

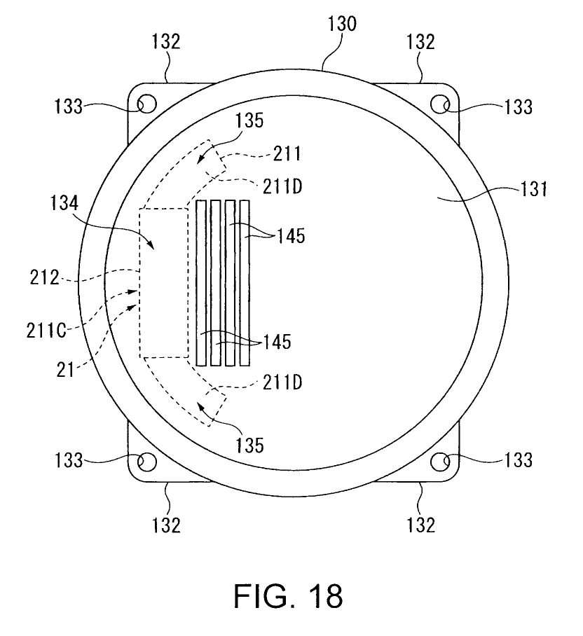

For example, a plurality of amorphous foil strips 145 may be arranged as shown in FIG. 18. The amorphous foil strips 145 are preferably positioned with the long sides along the secondary magnetic path formed between the pair of lead parts 211D and the amorphous foil strips 145 substantially parallel to the coil winding part 211C. When amorphous foil strips 145 are thus positioned, magnetic flux lines entering each of the amorphous foil strips 145 is inhibited from escaping in a different direction (such as widthwise, perpendicular to the length of the amorphous foil strips 145), induction of magnetic flux lines from one lead part 211D to the other lead part 211D is improved, and antenna characteristics can therefore be further improved.

The amorphous foil strips 145 may be formed such that each of the plural amorphous foil strips 145 has the same width as shown in FIG. 18.

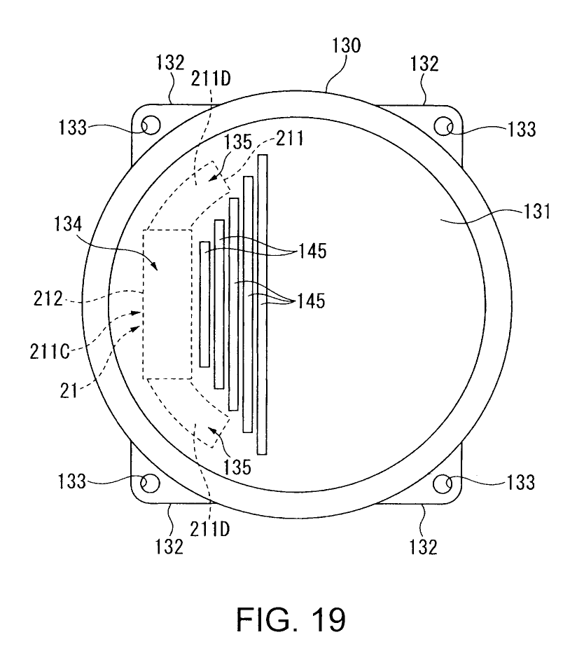

Alternatively, the amorphous foil strips 145 may have different lengths with the amorphous foil strips 145 closer to the coil winding part 211C being shorter and the length of the amorphous foil strips 145 increasing with distance from the coil winding part 211C so that the ends of each amorphous foil strips 145 are positioned in proximity to the lead parts 211D as shown in FIG. 19.

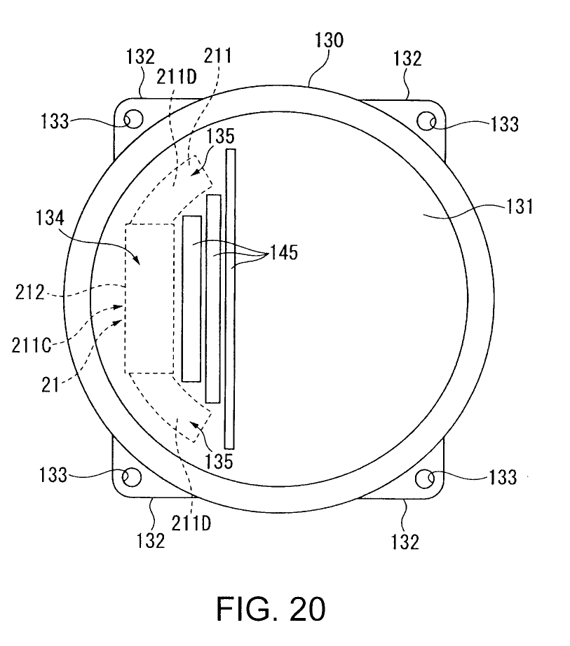

As shown in FIG. 20, each of the amorphous foil strips 145 may also have a different width.

The invention is further not limited to the configurations shown in FIG. 6, FIG. 10, or FIG. 13 to FIG. 20. The position where the amorphous foil member is placed must simply not overlap at least the lead-facing areas 135, and further preferably does not overlap the antenna-facing area 134, and the shape and size of the amorphous foil member may otherwise be determined as desired.

In the embodiments shown in FIG. 6 and FIG. 13 to FIG. 20 the back cover 130 has screw flanges 132 and is fastened by screws to the casing 110, but the invention is not so limited. For example, the amorphous foil member shown in FIG. 6 and FIG. 13 to FIG. 20 may be placed on back cover 130A that has a male thread formed around the outside and is screwed into a female thread formed on the casing 110 as described in the second embodiment.

The invention is further not limited to fastening the back cover 130 to the casing 110 by a screw method or methods that fasten the back cover 130A by screwing a screw part 136 into the casing 110. For example, the back cover may be pressed so that it snaps into the casing 110, and other methods of fastening the back cover to the casing 110 may also be used.

A foil member made of an amorphous metal such as a ferromagnetic material is used as the metal magnetic foil member in the foregoing embodiments, but the invention is not so limited. For example, any metal with higher magnetic permeability than the magnetic permeability of the back cover 130 may be used, and may be selected appropriately according to the metal used for the back cover 130.

Anisotropy is imparted while manufacturing the amorphous foil member 140 by rapidly drawing the amorphous material at high speed in a predetermined direction, but the invention is not so limited and an amorphous foil member 140 without normal anisotropy may be used.

The foregoing embodiments are described as disposing the amorphous foil member 140, 141 or amorphous foil layer 142, 144 at a position where it does not overlap the antenna-facing area 134, but the invention is not so limited. More specifically, it is sufficient if the amorphous foil member 140, 141 or amorphous foil layer 142, 144 do not overlap the lead-facing areas 135, and configurations in which the amorphous foil member 140, 141 or amorphous foil layer 142, 144 does not overlap the lead-facing areas 135 but partially overlaps the area opposite the coil winding part 211C are also conceivable. The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. An electronic timepiece with an internal antenna comprising:
an outside case including a metal back cover;
an antenna for receiving external radio frequency information, the antenna including a magnetic core that is long in one direction and is made from a magnetic material, and a coil that is wound around the magnetic core,
the magnetic core having a coil winding part around which is wound the coil positioned in the middle part in the lengthwise direction, and a pair of lead parts projecting from both sides of the coil winding part;
a reception processor that processes the external radio frequency information received by the antenna;
a module that houses the antenna and the reception processor, and is housed inside the outside case; and
a metal magnetic foil member that has greater magnetic permeability than the back cover, and is positioned outside at least the lead-facing areas opposite the lead parts on the inside surface of the back cover facing the module.

2. The electronic timepiece with an internal antenna described in claim 1, wherein:
the metal magnetic foil member is an amorphous foil member made from an amorphous metal.

3. The electronic timepiece with an internal antenna described in claim 1, wherein:
the metal magnetic foil member is positioned on the inside surface of the back cover outside the areas opposite both the lead parts and the coil winding part.

4. The electronic timepiece with an internal antenna described in claim 1, wherein:
the metal magnetic foil member is positioned along the lengthwise direction of the antenna parallel to the coil winding part.

5. The electronic timepiece with an internal antenna described in claim 1, wherein:
the outside case includes a substantially cylindrical casing to the bottom of which is affixed the back cover;
the antenna is formed substantially in an arc along the inside surface of the casing; and
the metal magnetic foil member is positioned substantially along the area opposite a chord joining both ends of the antenna on the inside surface of the back cover.

6. The electronic timepiece with an internal antenna described in claim 1, wherein:
the outside case has a substantially cylindrically shaped body with an engaging part on the bottom end side for freely engaging and disengaging the back cover;
the back cover can freely engage and disengage the engaging part of the body by rotating the back cover; and
the metal magnetic foil member is substantially round and is positioned concentrically to the center of back cover rotation.

7. The electronic timepiece with an internal antenna described in claim 1, wherein:
the metal magnetic foil member is affixed to the inside surface of the back cover by an intervening adhesive layer.

8. The electronic timepiece with an internal antenna described in claim 1, wherein:
the metal magnetic foil member comprises a plurality of stacked layers.

9. The electronic timepiece with an internal antenna described in claim 1, wherein:
the metal magnetic foil member is positioned on the inside surface of the back cover through an intervening nonconductive member.
